(19) United States
(12) Patent Application Publication
(10) Pub. No.: US 2009/0164631 A1
(43) Pub. Date: Jun. 25, 2009

(54) Centralized Services Management (CSM) System

(76) Inventor: Marcus L. Wooley, Annapolis, MD (US)

Correspondence Address: MAXVALUEIP CONSULTING, 11204 ALBERMYRTLE ROAD, POTOMAC, MD, 20854, US

(21) Appl. No.: 11/960,707

(22) Filed: Dec. 20, 2007

(51) Int. Cl. G06F 15/173

(52) U.S. Cl. 709/225

(57) ABSTRACT

In this presentation, we show a system and method for in-depth tracking and information, reporting capabilities, and maintaining a high level of availability for its customer information and tracking database facility. The purpose is to show an effective and economical way to automate and monitor/manage the whole operation for centralized services management. Automating the whole process and tracking all the components and issues provide efficiency and saving to the users, with less chance of error, down-time, and under-estimating/over-estimating the resources or inventories.

### BACKGROUND

The vending company is serving millions of customers every day through thousands of client sites. XYZ Vending has created a new level of service for its customers with a growing list of restaurant brands and offering a unique dining experience that no one else delivers.

Project Scope XYZ Vending has a requirement to provide in-depth tracking and information, reporting capabilities, and maintain a high level of availability for its customer information and tracking database facility. The purpose of this patent disclosure is to teach an effective and economical means by which this objective can be accomplished.

Even with technology which allows the company to read and display another computer's documents, paper reduction goals will never be accomplished without targeted effort to automate. The use of e-mail in an organization causes a two-fold increase in paper consumption. The primary objective of the project is to develop a system to better manage, track, schedule, report and house the data, critical to warehouse operations and management.

Automating the whole process and tracking all the components and issues provide efficiency and saving to the users, with less chance of error, down-time, and under-estimating/over-estimating the resources or inventories.

Some prior art/references are:
Sears repair center, for appliances.
U.S. Pat. No. 7,165,041, Web-based architecture sales tool
U.S. Pat. No. 7,149,698, Business alliance identification in a web architecture Framework
U.S. Pat. No. 7,130,807, Technology sharing during demand and supply planning in a network-based supply chain environment
U.S. Pat. No. 7,124,101, Asset tracking in a network-based supply chain environment
U.S. Pat. No. 7,120,928, Secure selective sharing of account information on an internet information aggregation system
U.S. Pat. No. 6,957,186, System method and article of manufacture for building, managing, and supporting various components of a system
U.S. Pat. No. 6,721,713, Business alliance identification in a web architecture framework
U.S. Pat. No. 6,671,818, Problem isolation through translating and filtering events into a standard object format in a network based supply chain
U.S. Pat. No. 6,615,166, Prioritizing components of a network framework required for implementation of technology
U.S. Pat. No. 6,606,744, Providing collaborative installation management in a network-based supply chain environment
U.S. Pat. No. 6,536,037, Identification of redundancies and omissions among components of a web based architecture
U.S. Pat. No. 6,519,571, Dynamic customer profile management
U.S. Pat. No. 6,473,794, System for establishing plan to test components of web based framework by displaying pictorial representation and conveying indicia coded components of existing network framework.

However, none of the above has the features of the current invention as described below.

### SUMMARY

Statement of Work and Detailed Technical Requirements: Telephone inquires shall be responded to within a timely manner of receipt. If the dispatcher cannot provide an answer to the inquiry, they should alert the customer as to when the customer should expect a resolution. The contractor should adhere to recommended standards for customer service centers, whenever applicable: (1) Responds by technicians within days of calls received; (2) Give callers an estimate of response time; (3) Answer questions or estimate response time within days of receiving original inquiry; and (4) Keep clients abreast of changes to the status.

Volume of Work: (how many calls, inquires, etc. do you expect to receive?): The dispatcher operating the hotline must make provisions to handle potential spikes of traffic and minimize call waiting times. The Information collected must be entered into the system, in order for viewing and editing by the appropriate individuals or management. The concept of an electronic inbox will be utilized with the information being automatically available to management for scheduling.

Volume of Work—Email: The current vending operation does not include answering email inquires; therefore, no historical data on email volume exists. XZY Company does not anticipate the volume of email work, which will eventually equal the call volume received.

Development of Database: The XYZ Vending operator will construct and maintain a database of inquires and response. The dispatcher will be expected, in cooperation with management, to keep the database populated with new questions and response, daily. XYZ Vending will identify new database categories and approve response to the newly-added inquires. This database will be built on the current information available and provided. XYZ Vending will furnish its current database of agencies as a foundation for content and structure. The contractor will develop and populate the database in conjunction with, and to support, the roll-out of the new system.

Technological Requirements: The contractor shall provide and maintain all technology infrastructures to support the requirements identified in the SOW (statement of work). This includes inquiry processing technology and services, routing and management system, knowledge-base system, database management system, work force management system, customer response automation, complaint management system, service monitoring and quality control system, training equipment, hardware system, and interactive voice mail system. All technology infrastructures, including database designs, shall meet the minimum requirements set forth in the prior section of the contract. Call processing, routing, and management systems shall incorporate automated capabilities to perform periodic checks on the systems to verify operational status of the contractor systems.

Security Requirement: XYZ Vending shall comply with the corporate information systems security requirements of the base contract, including certification and accreditation (C&A), security plan, test and evaluation, and implementation plan. Guidelines for complying with the corporate information systems security requirements must be strictly adhered to.

Hardware Requirements: A newly-purchased server configuration would take on the processing needs specifically for the newly proposed CSM software application. The new server hardware would be under warranty for full coverage in the event of a failure. The new server configurations consist of an application server and a separate database server. This server configuration will allow the roles for processing the user logins, user validation, directory searches, and data queries, to be processed on the application server, while the data warehousing and database management processing will take place on a separate database server. Since information contained in the CSM database can then be accessed from any local PC workstation via the web browser, it will not be necessary to purchase any new hardware for the end-users.

Performance Standards:

1. Calls are answered 8 hours a day, 5 days a week.

2. Operators are responsive to every caller, making referrals to other agencies, when the call is not germane to their subject matter.

3. Accurate referral contract information (for service providing organization) is maintained and readily available to all operators.

4. All inquires are responded to, within hours or days.

5. Reports of activity—progress, case handling, and all associated metrics—will be furnished in a future release. Report specifics will be based on mutually-agreed-upon criteria.

6. Cooperating agencies in identified cities are identified, screened, and approved (Service outlined and maintained in a usable database).

### BRIEF DESCRIPTION OF THE FIGURES

FIG. 1 shows data hosting.

FIG. 2 shows a diagram for customer complaints.

FIG. 3 shows a customer complaint screen.

FIG. 4 shows the Vending Operation.

FIG. 5 shows managing equipment.

FIG. 6 shows a scheduling logistics.

FIG. 7 shows a Rolling terminal.

FIG. 8 shows a CSM deployment.

FIG. 9 shows the environment.

FIG. 10 shows our environment.

FIG. 11 shows an overall system.

### DETAILED DESCRIPTION

Task Requirements: Strategic Use Case:

USE CASE: Centralized Service Management (CSM) System:

We Will Examine the Following Use Cases:

TABLE I
Use cases:

| Primary | | |
|---|---|---|
| Actor | Use Case | |
| Customer | 1. | Initiates Service Request and Orders |
| Customer | 2. | Initiates Equipment Move Request |
| Manager | 3. | Creates Equipment Move Request |
| Dispatcher | 4. | Creates Service Tickets |
| Clerk | 5. | Log Equipment Inventory |
| Clerk | 6. | Close Equipment Move and Service |
| | | Request |
| Route | 7. | Stock Machines Inventory |
| Driver | | |
| Technician | 8. | Prepare Equipment for Move |
| Technician | 9. | Service Machines |
| Technician | 10. | Installation and Pickup of Equipment |
| Scheduler | 11. | Schedule Equipment Move Request |
| Manager | 12. | Manage all Requests |

These are the Generic Situations, with Possible Options for Each Situation and Generic Questions:

USE CASE DETAIL: The required business functions.

USED BY: Business Classes options are: (Customer, Dispatcher, Clerk, Route Driver, Technician, Scheduler, and Manager)

DESCRIPTION:

INPUTS: Details what information flows from the user to the system for this particular Use Case.

OUTPUTS: Details what information flows from the system to the external environment.

PRE-CONDITIONS: What constraints apply on the inputs (or the internal system, as a whole, in some cases)?

POST-CONDITIONS: What changes does the Use Case make to the internal system state?

NORMAL COURSE: What are the sequences of events the user must perform for this particular Use Case?

SPECIAL REQUIREMENTS: What validity checks does the system apply to the information being processed?

Now, Let us Examine Each Use Case in More Details:
1. USE CASE DETAIL: Initiate Service Request and Orders (Telephone Fax, Email):

USED BY: Customer

DESCRIPTION: Maintenance or sales requested by the customer to be tracked and managed through the application.

INPUTS: Calls are received from customer or sales person.

OUTPUT: Trouble ticket assignment and routed to the appropriate driver for machine service. A history of service request and orders will be recorded for each customer site.

PRE-CONDITIONS: N/A

POST-CONDITIONS: N/A

NORMAL COURSE:

Dispatcher log callers service request.
2. USE CASE DETAIL: Initiate Equipment Move Request (Telephone Fax, Email):

USED BY: Customer

DESCRIPTION: Equipment move requested to be tracked and managed through the application.

INPUTS:

OUTPUT: Request is elevated to the appropriate manager.

PRE-CONDITIONS: N/A

POST-CONDITIONS: N/A

NORMAL COURSE:

Route manager forwards request to the scheduling managers.
3. USE CASE DETAIL: Initiate Equipment Move Request

USED BY: Manager

DESCRIPTION: Initiated by negotiated changes between management and the customer representative. The transfer of machines from one place (warehouse or customer) to another, and will identify where, within each customer location, the machines can be found. Logging the move request into the database requires the assignment of a tracking number. This number cannot be changed, nor can the machine transfer be erased, although the request can be changed or cancelled.

INPUT: Request is elevated to the appropriate manager.

Machine(s) transferred out of a Customer or Warehouse.

Machine(s) transferred into a Customer or Warehouse.

Dispatch request assigned to Route Driver for inventory operations.

Close out Service Request.

OUTPUT: Equipment move request form must be completed for machines operated by Vendor.

PRE-CONDITIONS: User security for move request is role-based and will determine who can create, view, or change the move request.

POST-CONDITIONS: N/A

NORMAL COURSE:

Manager log callers move request.

Request can be viewed or printed, and possibly correct any of the tickets in this history.
4. USE CASE DETAIL: Create Service Ticket

USED BY: Dispatcher

DESCRIPTION: Orders are used to record all sales to customers. Purchases are also used to record all purchases from suppliers. Routing issues are used to record all inventory operations of product from the warehouse to each route. Service calls are used to record Machine malfunctions requiring technicians. Machine parts request are initiated by the technician. Logging the service request into the database requires the assignment of a tracking number. This number cannot be changed, nor can the machine transfer be erased, although the request can be changed or cancelled.

INPUTS: Ticket type options are: (Orders, Purchases, Inventory Operations, Service Calls, Parts Request, and Machine Transfers):

Service Call Information.

Machine and Location Information.

Dispatch request assigned to Route Driver.

Close out Service Request.

OUTPUT: Request is elevated to the appropriate manager. Route driver is assigned to trouble ticket.

PRE-CONDITIONS: User security for service request is role-based and will determine who can create, view, or change the service ticket.

POST-CONDITIONS: N/A

NORMAL COURSE:

Dispatcher must be able to open or retrieve a ticket at the start of a phone call.

Dispatcher forwards request to the appropriate route drivers.

Request can be viewed or printed, and possibly correct any of the tickets in this history.
5. USE CASE DETAIL: Log Equipment Inventory

USED BY: Clerk

DESCRIPTION: The amount of product transferred into the selected warehouse, or from one of your other warehouses. Total shipments directly from the warehouse during a time period. This includes parts usage on service tickets and returned equipment that increases the warehouse inventory. Have an individual data enter the information into the database system.

INPUTS:

Warehouse counts before any activity on that date.

Total purchases received from inventory suppliers.

Total products transferred into the warehouse.

Warehouse counts after all other activities for the day were finished.

OUTPUT: Update to the database will include preparer's and approver's signature information, as well as date-time-stamp.

PRE-CONDITIONS: N/A

POST-CONDITIONS: N/A

NORMAL COURSE:
6. USE CASE DETAIL: Close Equipment Move and Service Request

USED BY: Clerk

DESCRIPTION: Equipment installer must notify the Clerk of the completion information.

INPUTS:

Tracks the signature information for each movement process.

Updates the database system.

OUTPUT: Request is completed, and account status updated.

PRE-CONDITIONS: N/A

POST-CONDITIONS: N/A

NORMAL COURSE:
7. USE CASE DETAIL: Stock Machines Inventory

USED BY: Route Driver

DESCRIPTION: The route driver function related to restocking inventory or delivering the order.

INPUTS:

Inventory levels at the beginning of each day or period.

Total sales during the day or time period.

Total product issued to drivers during the time period.

Total returns from driver during the time period.

Inventory levels at the end of the day or period.

OUTPUT: Detail service activities by subcontract account or vending branch.

PRE-CONDITIONS: N/A

POST-CONDITIONS: N/A

NORMAL COURSE:
8. USE CASE DETAIL: Prepare Equipment for Move

USED BY: Technician

DESCRIPTION: Checklist of items related to the machine Prep process.

INPUTS:

OUTPUT: Request is elevated to the appropriate manager.

PRE-CONDITIONS: N/A

POST-CONDITIONS: N/A

NORMAL COURSE:
9. USE CASE DETAIL: Service Machines

USED BY: Technician

DESCRIPTION: When a service call is actually dispatched to the appropriate technician or manager. Service machines records all repairs either in the warehouse or at the customer site. Every service call or general maintenance call is assigned a tracking number. This number cannot be changed, nor can the machine transfer be erased. Although, the request can be changed or cancelled.

INPUTS:

Labor hours and parts request for service call

Number of parts used for service call.

Total labor and parts cost for service call.

The number of service tickets entered.

The average hours to respond.

The total time on location making repairs.

Close out Machine service.

OUTPUT: Request is completed, and dispatcher is notified of account status updates.

PRE-CONDITIONS: User security for service request is role-based and will determine who can create, view, or change the service ticket.

POST-CONDITIONS: When the repair is accomplished. The service call cannot be posted or completed until the repair information has been entered.

NORMAL COURSE:

You can assign a call to one of the technicians before they call in.

The service request is dispatched to a technician normally by phone or radio.
10. USE CASE DETAIL: Installation and Pickup of Equipment

USED BY: Technician

DESCRIPTION: Physical movement of equipment from the warehouse to the customer account/location.

INPUTS:

OUTPUT: Request is elevated to the appropriate manager.

PRE-CONDITIONS: N/A

POST-CONDITIONS: N/A

NORMAL COURSE:

Calls are received from Customer.

Dispatcher forwards call to Route Manager.
11. USE CASE DETAIL: Schedule Equipment Move Request

USED BY: Scheduler

DESCRIPTION: Coordinated effort to handle both equipment and inventory management with respect to an individual customer and location. Multi-Route scheduling will be required to handle both the installers and route driver's schedules.

INPUTS:

Master Movement List.

Equipment Install Calendar.

Master Route List.

OUTPUT: Installation Calendar of events.

PRE-CONDITIONS: N/A

POST-CONDITIONS: N/A

NORMAL COURSE:
12. USE CASE DETAIL: Manage all the Requests

USED BY: Manager

DESCRIPTION: Inventory control is the ability to track the status of both service and move requests at any point within the process. Inventory Control Process provides information to efficiently manage the flow of materials, effectively utilize people and equipment, coordinate internal activities, and communicate with customers. Inventory Management and the activities of Inventory Control do not make decisions or manage operations. They provide the information to Managers who make more accurate and timely decisions to manage their operations.

INPUTS:

Master Movement List.

Equipment Install Calendar.

Master Route List.

Master Complaint List.

OUTPUT: Each Request call can be assigned a priority: Low, Medium, or High for immediate attention.

PRE-CONDITIONS: N/A

POST-CONDITIONS: N/A

NORMAL COURSE:

Managers can view all service and movement requests and status information.

These are the Components of Our System, and the Corresponding Advantages/Features:

Application vision:
Data Hosting
Office automation
Management reporting
Rapid response
Statistical data
Enhance performance
Improve productivity

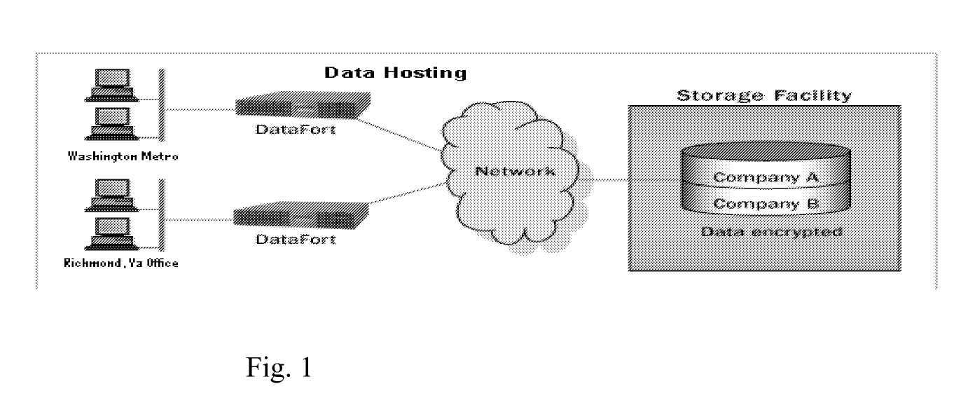

FIG. 1 shows data hosting, featuring value (low cost), security, and access:
Streamlined data collection, maintenance, analysis and reporting
Increased accuracy and completeness of data
Total data access throughout the organization

Office Automation:
Innovative solutions
Reliable, available, and scaleable
Workflow Management
Data warehouse technology
Equipment tracking
Operations management

Management Reporting:
Track equipment location
Monitor schedule
Monitor equipment pickup
Monitor equipment delivery
Synchronize pickups, repairs, installs, and inventory operations

Rapid Response:
Reply to customer inquiry
Inputting customer calls
Coordinate efforts
Procedures
Response measurements

Statistical Data:
Provide manager reports
Measurable outputs
Accuracy
Speed
Success with challenging problems
Effectiveness

For:
Scheduling logistics
Prep and QA logistics
Installer logistics
Route logistics
Driver logistics
Dispatcher logistics

Enhance Performance:
Automation
Procedures
Paper flow reduction
Improve morale
Interruptions resolved more effectively
Staff attitudes
Improve communication

For:
Installation calendar
Equipment move request
Machine preparation
Quality assurance
Master route list
Rolling terminal
Management

Application Features
Customer complaints
Vending operations
Managing equipment
Scheduling
Rolling terminal service

For:
Installation calendar
Equipment move request
Machine preparation
Quality assurance
Master route list
Rolling terminal
Management

Customer Complaints
Customer call volume
Response time management
Managing service tickets
Equipment inventory log
Quality assurance

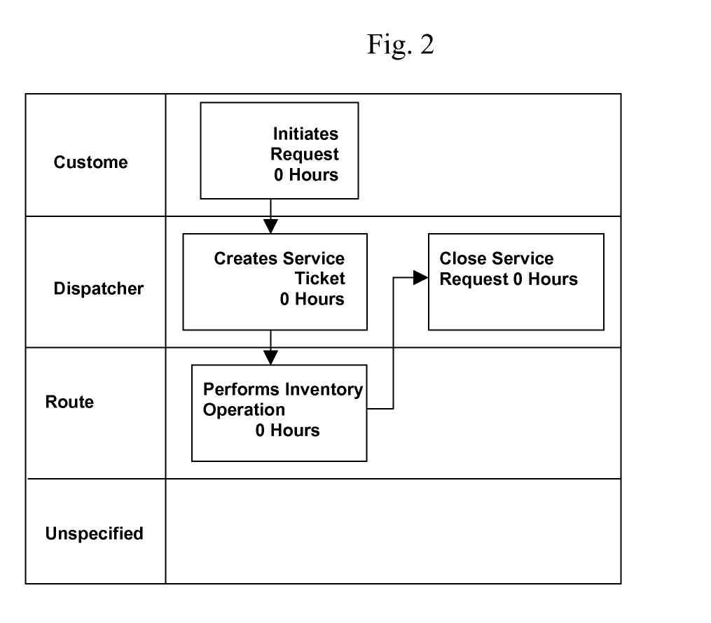

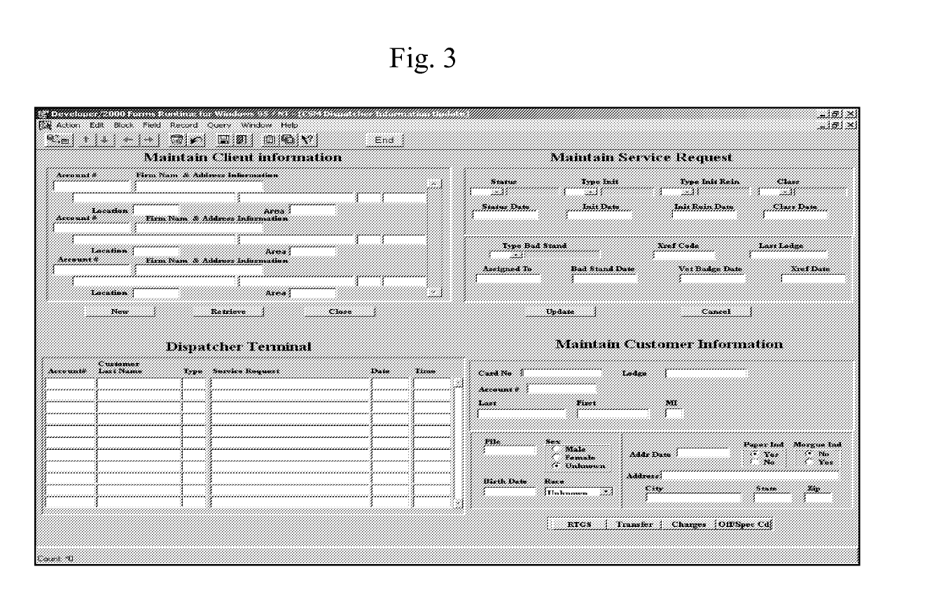

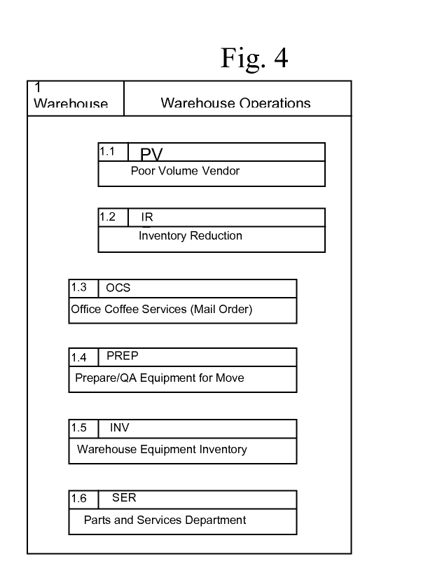

FIG. 2 shows a diagram for customer complaints. FIG. 3 shows a customer complaint screen. FIG. 4 shows the Vending Operation.

Vending Operations
Setting standards
Monitoring processes
Tracking accuracy
Accountability
Inventory reduction
PVV reduction

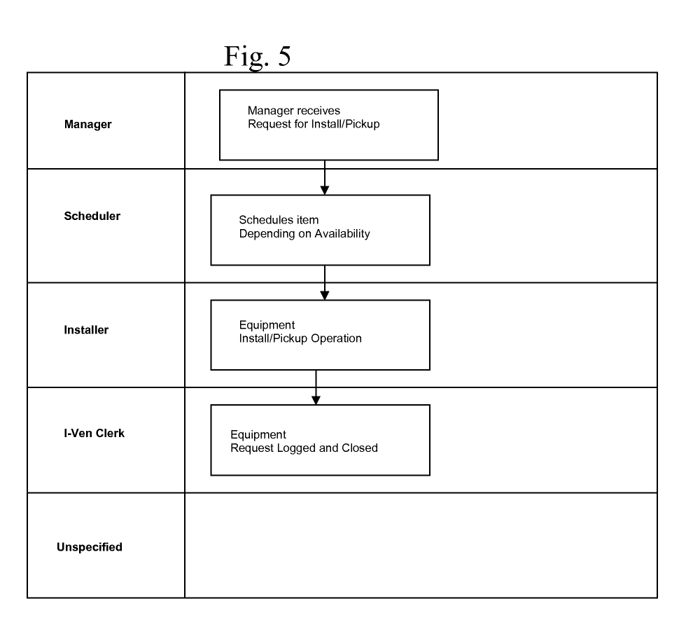

Managing Equipment (see FIG. 5)
Scheduling
Equipment request log
Master movement list management
Management

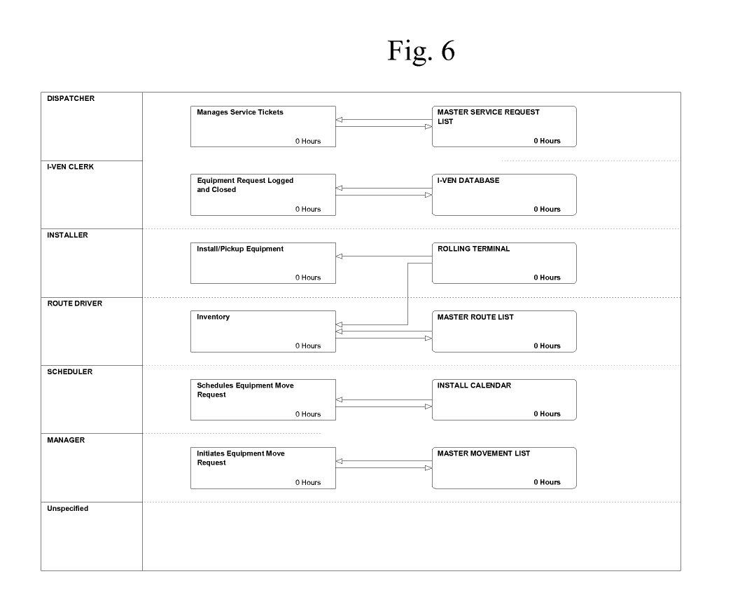

Scheduling Logistics (See FIG. 6)
Installation calendar
Schedule equipment move request
Machine preparation
Quality assurance procedures
Master route list management
Rolling terminal
Management

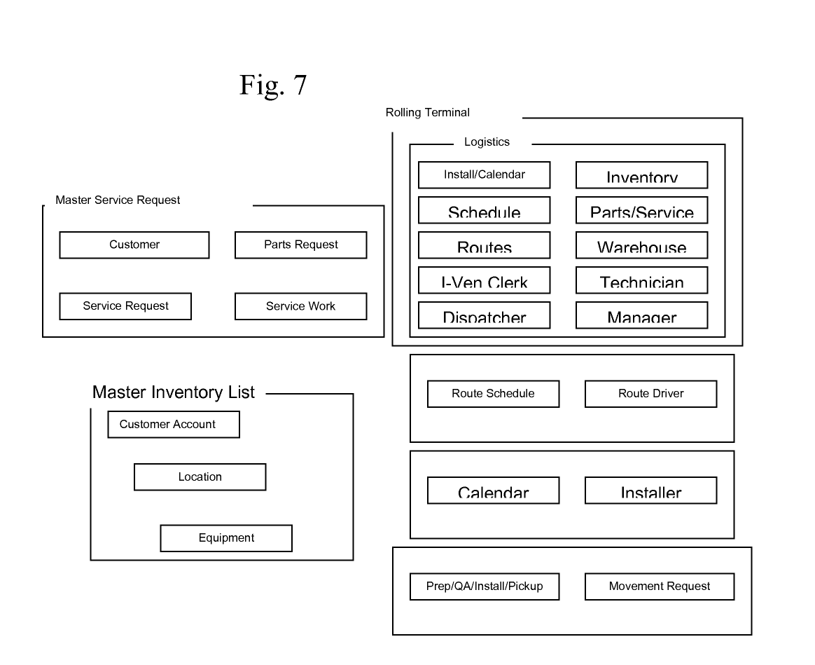

Rolling Terminal (See FIG. 7)
Scheduling logistics
Prep and QA logistics
Installer logistics
Route logistics
Equipment logistics
Dispatcher logistics

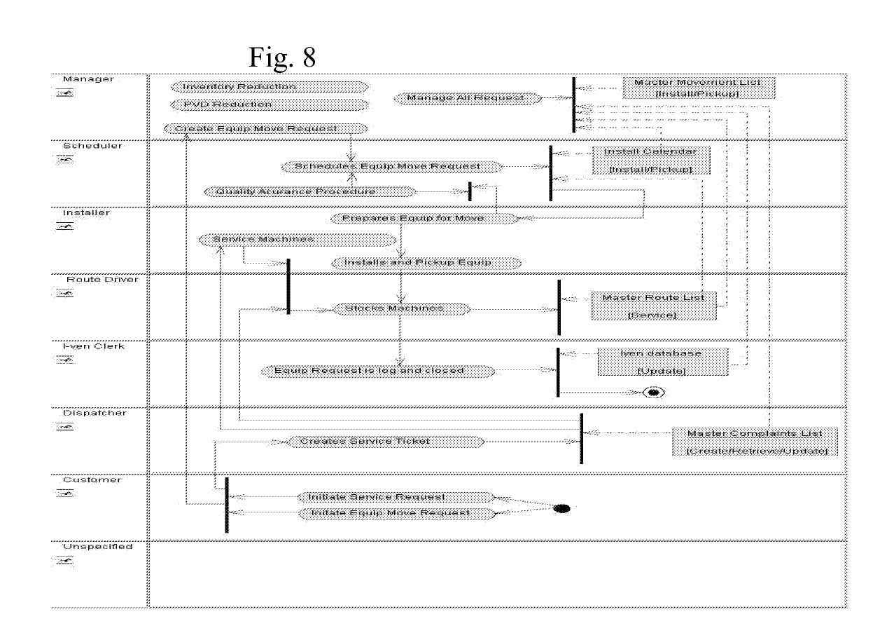

CSM Deployment (CSM Work Process in FIG. 8)
H/S Requirements
Database Architectural Design
Software Application Design
Data Migration Plan
Code/Build Phase and Document
Test Plan
Implementation Plan

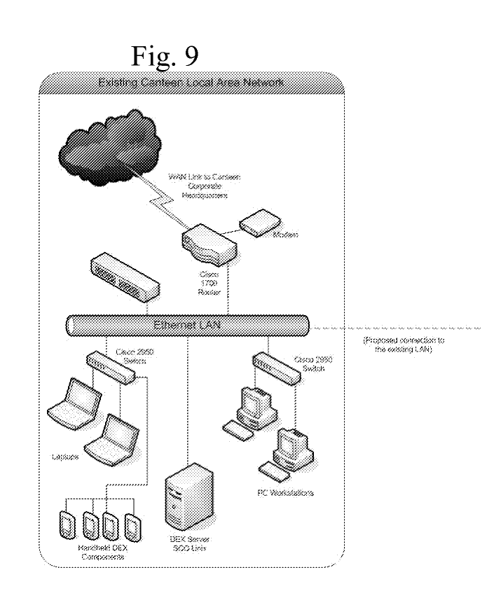

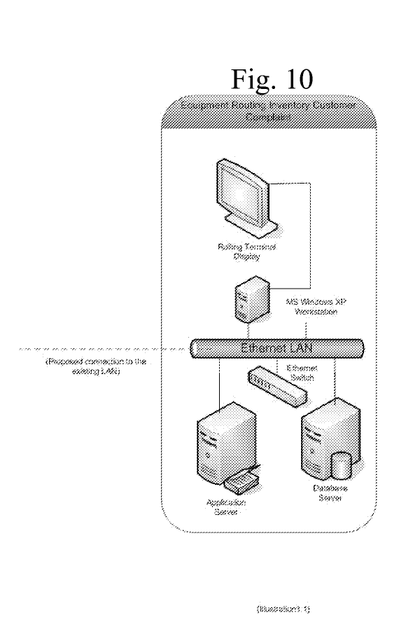

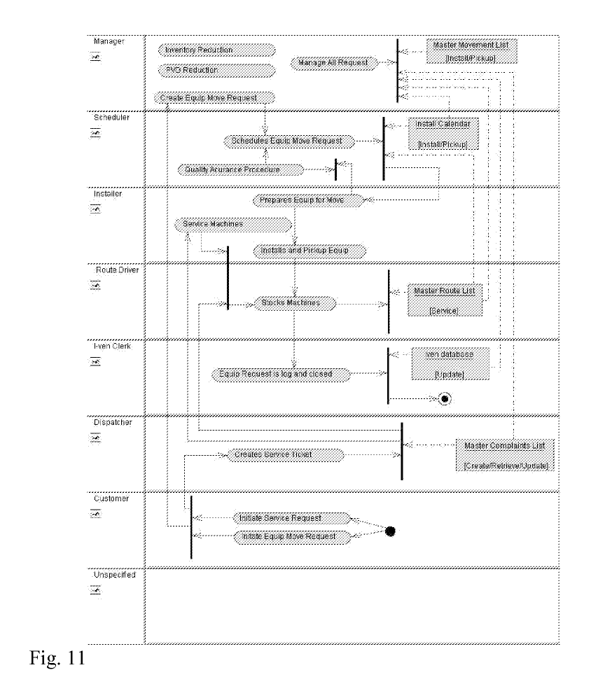

FIG. 9 shows the environment. FIG. 10 shows our environment. FIG. 11 shows an overall system. The system above can be used for any application in which services and objects are distributed, repaired, or updated, periodically. The more ordered the procedures, the more efficient the whole process. The resources and inventories are used or applied very efficiently. Fewer things are wasted, or stored for no reason. The whole process is optimized, and fewer resources are used for the operation. To optimize the usage of resources, fuzzy logic and neural networks can also be applied to our system. The system can be integrated or cascaded to other payment systems or to each other. The structure can be hierarchical, in which case subsystems operate within a bigger system.

### HERE ARE SOME EXAMPLES

### Example 1

A centralized services management system to manage a network of the vending machines, said system comprising:
A user interface,
A data warehouse,
Operations management module,
Tracking module,
Monitoring schedule module,
Customer call receiving module, and
Customer inquiry replying module,
Wherein a customer initiates a request,
Wherein a dispatcher creates a service ticket,
Wherein a route driver performs an inventory operation,
Wherein a manager initiates an equipment move request for one or more vending machines,
Wherein said manager interacts with a master movement list, and
Wherein a rolling terminal is connected to an application server and a database server through a computer or communication network.

Some of the Features Associated with the Above System Are:
a master route list.
wherein said master route list comprises a route schedule and a route driver list.
a master inventory list.
wherein said master inventory list comprises a customer account, a location list, and an equipment list.
a master service request list.
wherein said master service request list comprises a customer complaints list, a parts request list, a service request list, and a service work order list.
wherein said computer or communication network is a local area network.
wherein an installer prepares an equipment for move.

### Example 2

A centralized services management system to manage a network of the vending machines, said system comprising:
A user interface,
A data warehouse,
Operations management module,
Tracking module,
Monitoring schedule module,
Customer call receiving module, and
Customer inquiry replying module,
Wherein a customer initiates a request,
Wherein a dispatcher creates a service ticket,
Wherein a route driver performs an inventory operation,
Wherein a manager initiates an equipment move request for one or more vending machines,
Wherein said manager interacts with a master movement list,
Wherein said system manages old customer complaints and new customer complaints,
Wherein said system manages routing, old tickets, and new tickets, and
Wherein a delay in the scheduled service or operation triggers a shift or adjustment of tickets in queue, with an automatic notice sent to said customer.

Some of the Features Associated with the Above System Are:
wherein said tracking module comprises an RFID tag.
wherein said tracking module comprises a GPS module to find a coordinate or location, for global positioning.
wherein said automatic notice sent to said customer is done by e-mail or text messaging.
wherein said automatic notice sent to said customer is done by telephone or video-phone.
wherein a scheduler schedules an equipment move request.
wherein a scheduler applies a quality assurance procedure.
wherein said manager optimizes the routing and scheduling.
wherein the scheduling and routing information is stored in a distributed network of databases, computers, storages, or servers.
wherein said system is based on neural network training and fuzzy logic membership function.
wherein the access of different users to said system is based on biometrics, encryption, PKI, password, role-based, context-based, fee-based, permission-based, temporary-based, or license-based.

Any variation of the above is also intended to be covered by the current disclosure and patent.

1. A centralized services management system to manage a network of the vending machines, said system comprising:
A user interface,
A data warehouse,
Operations management module,
Tracking module,
Monitoring schedule module,
Customer call receiving module, and
Customer inquiry replying module,
Wherein a customer initiates a request,
Wherein a dispatcher creates a service ticket,
Wherein a route driver performs an inventory operation,
Wherein a manager initiates an equipment move request for one or more vending machines,
Wherein said manager interacts with a master movement list, and
Wherein a rolling terminal is connected to an application server and a database server through a computer or communication network.

2. A centralized services management system as recited in claim 1, wherein said system further comprising: a master route list.

3. A centralized services management system as recited in claim 2, wherein said master route list comprises a route schedule and a route driver list.

4. A centralized services management system as recited in claim 1, wherein said system further comprising: a master inventory list.

5. A centralized services management system as recited in claim 4, wherein said master inventory list comprises a customer account, a location list, and an equipment list.

6. A centralized services management system as recited in claim 1, wherein said system further comprising: a master service request list.

7. A centralized services management system as recited in claim 6, wherein said master service request list comprises a customer complaints list, a parts request list, a service request list, and a service work order list.

8. A centralized services management system as recited in claim 1, wherein said computer or communication network is a local area network.

9. A centralized services management system as recited in claim 1, wherein an installer prepares an equipment for move.

10. A centralized services management system to manage a network of the vending machines, said system comprising:
A user interface,
A data warehouse,
Operations management module,
Tracking module,
Monitoring schedule module,
Customer call receiving module, and
Customer inquiry replying module,
Wherein a customer initiates a request,
Wherein a dispatcher creates a service ticket,
Wherein a route driver performs an inventory operation,
Wherein a manager initiates an equipment move request for one or more vending machines,
Wherein said manager interacts with a master movement list,
Wherein said system manages old customer complaints and new customer complaints,
Wherein said system manages routing, old tickets, and new tickets, and
Wherein a delay in the scheduled service or operation triggers a shift or adjustment of tickets in queue, with an automatic notice sent to said customer.

11. A centralized services management system as recited in claim 10, wherein said tracking module comprises an RFID tag.

12. A centralized services management system as recited in claim 10, wherein said tracking module comprises a GPS module to find a coordinate or location.

13. A centralized services management system as recited in claim 10, wherein said automatic notice sent to said customer is done by e-mail or text messaging.

14. A centralized services management system as recited in claim 10, wherein said automatic notice sent to said customer is done by telephone or video-phone.

15. A centralized services management system as recited in claim 10, wherein a scheduler schedules an equipment move request.

16. A centralized services management system as recited in claim 10, wherein a scheduler applies a quality assurance procedure.

17. A centralized services management system as recited in claim 10, wherein said manager optimizes the routing and scheduling.

18. A centralized services management system as recited in claim 10, wherein the scheduling and routing information is stored in a distributed network of databases, computers, storages, or servers.

19. A centralized services management system as recited in claim 10, wherein said system is based on neural network training and fuzzy logic membership function.

20. A centralized services management system as recited in claim 10, wherein the access of different users to said system is based on biometrics, encryption, PKI, password, role-based, context-based, fee-based, permission-based, temporary-based, DRM-based, contract-based, or license-based.
